(19) United States
(12) Patent Application Publication
(10) Pub. No.: US 2004/0138876 A1
(43) Pub. Date: Jul. 15, 2004

(54) Method and apparatus for artificial bandwidth expansion in speech processing

(75) Inventors: Loura Kallio, Espoo (FI); Paavo Alku, Helsinki (FI); Kimmo Kayhko, Riihimaki (FI); Matti Kajala, Tampere (FI); Paivi Valve, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/341,332

(22) Filed: Jan. 10, 2003

(51) Int. Cl. G10L 19/06

(52) U.S. Cl. 704/209

(57) ABSTRACT

A method and device for improving the quality of speech signals transmitted using an audio bandwidth between 300 Hz and 3.4 kHz. After the received speech signal is divided into frames, zeros are inserted between samples to double the sampling frequency. The level of these aliased frequency components is adjusted using an adaptive algorithm based on the classification of the speech frame. Sound can be classified into sibilants and non-sibilants, and a non-sibilant sound can be further classified into a voiced sound and a stop consonant. The adjustment is based on parameters, such as the number of zero-crossings and energy distribution, computed from the spectrum of the up-sampled speech signal between 300 Hz and 3.4 kHz. A new sound with a bandwidth between 300 Hz and 7.7 kHz is obtained by inverse Fourier transforming the spectrum of the adjusted, up-sampled sound.

### FIELD OF THE INVENTION

The present invention relates generally to a method and device for quality improvement in an electrically reproduced speech signal and, more particularly, to the quality improvement by expanding the bandwidth of sound.

### BACKGROUND OF THE INVENTION

Speech signals are traditionally transmitted in a telecommunications system in narrowband, containing frequencies in the range of 300 Hz to 3.4 kHz with a sampling rate of 8 kHz, in accordance with the Nyquist theorem. However, humans perceive speech more naturally if the bandwidth of the transmitted sound is wider (e.g., up to 8 kHz). Because of the limited frequency range, the quality of speech so transmitted is undesirable as the sound is somewhat unnatural. For this reason, the new wideband transmission standards such as the AMR (adaptive multi-rate) wideband speech codec, can carry frequencies up to 7 kHz. However, if the speech is originated from a narrowband network or a device having a narrowband speech encoder, the wideband-capable terminal or the wideband network will not offer any advantages regarding the naturalness of the transmitted speech because the upper frequency content is already missing in the transmission. Thus, it is advantageous and desirable to expand the bandwidth of the transmitted speech in order to improve the speech quality. In the past, a number of methods have been used for such purposes. For example, H. Yasukawa (“Quality Enhancement of Band Limited Speech by Filtering and Multirate Techniques”, Proc. Int. Conf. on Spoken Language Proc., pp. 1607-1610) discloses a method of spectrum widening utilizing aliasing effects in sampling rate conversion and digital filtering for spectral shaping in the higher frequency band of the widened spectrum. EP10064648 discloses a method of speech bandwidth expansion wherein the missing frequency components of the upper band of speech (e.g., between 4 kHz and 8 kHz) are generated at the receiver using a codebook. The codebook contains frequency vectors of different spectral characteristics, all of which cover the same upper band. Expanding the frequency range corresponds to selecting the optimal vector and adding into it the received spectral components of lower band (e.g., from 0 to 4 kHz).

While the prior art solutions improve the quality of the speech signal, they are generally costly to implement or they require significant training in order to synthesize the wideband speech.

Thus, it is advantageous and desirable to provide a method and device for speech signal quality improvement with low computation complexity.

### SUMMARY OF THE INVENTION

According to the first aspect of the present invention, there is provided a method of improving speech in a plurality of signal segments having speech signals in a time domain. The method is characterized by

upsampling the signal segments for providing upsampled segments in the time domain;

converting the upsampled segments into a plurality of transformed segments having speech spectra in a frequency domain;

classifying the speech signals into a plurality of classes based on at least one signal characteristic of the speech signals;

modifying the speech spectra in the frequency domain based on the classes for providing modified transformed segments; and

converting the modified transformed segments into speech data in the time domain.

Advantageously, the upsampling is carried out by inserting a value between adjacent signal samples in the signal segment, and the inserted value is zero.

Preferably, the speech signals include a time waveform having a plurality of crossing points on a time axis, and said at least one characteristic of the speech signals is indicative of the number of crossing points in a signal segment.

Preferably, each of the signal segments comprises a number of signal samples, and said at least one characteristic of the signal segments is indicative of a ratio of the number of crossing points in the signal segment and the number of signal samples in said signal segment.

Preferably, at least one signal characteristic of the speech signals is indicative of a ratio of an energy of a second derivative of the speech signals and an energy in the speech signals.

Preferably, the plurality of classes include a voiced sound and a stop consonant, and

the speech signals are classified as the voiced sound if the ratio is smaller than a predetermined value and

the speech signals are classified as the stop consonant if the ratio is greater than the predetermined value.

Preferably, the plurality of classes include a sibilant class and a non-sibilant class, and

the speech signals are classified as the sibilant class if the ratio is greater than a predetermined value, and

the speech signals are classified as the non-sibilant class if the ratio is smaller than or equal to the predetermined value.

Preferably, said at least one signal characteristic of the speech signals is indicative of a further ratio of an energy of a second derivative of the speech signals and an energy in the speech signals, and the speech signals are classified as the sibilant class if the further ratio is also greater than a further predetermined value.

Preferably, each of the speech spectra has a first spectral portion in a lower frequency range and a second spectral portion in a higher frequency range, and the second spectral portion is enhanced for providing the modified transformed segments if the speech signals are classified as the sibilant class and the second spectral portion is attenuated for providing the modified transformed segments if the speech signals are classified as the non-sibilant class.

Advantageously, each of the speech spectra has a first spectral portion in a lower frequency range and a second spectral portion in a higher frequency range, and smoothing the second spectral portion by an averaging operation prior to converting the modified transformed segments into the speech data in the time domain.

According to the second aspect of the present invention, there is provided a network device in a telecommunications network, wherein the network device is capable of

receiving data indicative of speech, and partitioning the received data into a plurality of signal segments having speech signals in a time domain. The network device is characterized by

an upsampling module for upsampling the signal segments for providing upsampled segments in the time domain;

a transform module for converting the upsampled segments into a plurality of transformed segments having speech spectra in a frequency domain;

a classification algorithm for classifying the speech signals into a plurality of classes based on at least one signal characteristic of the speech signals;

an adjustment algorithm for modifying the speech spectra in the frequency domain based on the classes for providing modified transformed segments; and

an inverse transform module for converting the modified transformed segments into speech data in the time domain.

Preferably, each of the signal segments comprises a number of signal samples for sampling a waveform having a plurality of crossing points on a time axis, and the classification algorithm is adapted to classify the speech signals based on a ratio of the number of crossing points and the number of signal samples in at least one signal segment.

Preferably, the classification algorithm is also adapted to classify the speech signals based on a ratio of an energy of a second derivative in the speech signal and an energy in at least one signal segment.

Advantageously, the plurality of classes include a sibilant class and a non-sibilant class, and each of the speech spectra has a first spectral portion in a lower frequency range and a second spectral portion in a higher frequency range, said device characterized in that the adjustment algorithm is adapted to

enhance the second spectral portion if the speech signals are classified as the sibilant class, and

attenuate the second spectral portion if the speech signals are classified as the non-sibilant class.

Advantageously, the adjustment algorithm is also adapted to smooth the second spectral portion by an averaging operation.

According to the third aspect of the present invention, there is provided a sound classification algorithm for use in a speech decoder, wherein speech data in the speech decoder is partitioned into a plurality of signal segments having speech signals in a time domain and each signal segment includes a number of signal samples, and wherein the speech signals include a time waveform having a plurality of crossing points on a time axis. The classification algorithm is characterized by

classifying the speech signals into a plurality of classes based on a ratio of the number of crossing points and the number of signal samples in at least one signal segment.

Preferably, the speech signals are classified into a sibilant class and a non-sibilant class, and the speech signals are classified as the sibilant class if the ratio is greater than a predetermined value.

Preferably, the classifying is also based on a further ratio of an energy of a second derivative of a second derivative of the speech signal and an energy in said at least one signal segment.

Preferably, the speech signals are classified into a sibilant class and a non-sibilant class, and the speech signals are classified as the sibilant class if the ratio is greater than a first predetermined value and the further ratio is greater than a second predetermined value. The the first predetermined value can be substantially equal to 0.6, and the second predetermined value can be substantially equal to 8.

According to the fourth aspect of the present invention, there is provided a spectral adjustment algorithm for use in a speech decoder capable of

receiving speech data,

partitioning speech data into a plurality of signal segments having speech signals in the time domain,

upsampling the signal segments for providing upsampled segments, and

converting the upsampled segments into a plurality of transformed segments, each having a first speech spectral portion in a first frequency range and a second speech spectral portion in a second frequency range higher than the first frequency range. The adjustment algorithm is characterized by

enhancing the second speech spectral portion, if the speech signals are classified as a sibilant class;

attenuating the second speech spectral portion, if the speech signals are classified as a non-sibilant class; and

smoothing the second speech spectral portion by an averaging operation.

Preferably, when the speech signals in at least two consecutive signal segments are classified as the sibilant class, said at least two consecutive signal segments including a leading segment and at least one following segment, wherein the second speech spectral portion in the leading segment is enhanced by a first factor, and the second speech spectral portion in said at least one following segment is enhanced by a second factor smaller than the first factor.

The present invention will become apparent upon reading the description taken in conjunction with FIGS. 1 to 12.

### BRIEF DESCRIPTION OF THE DRAWINGS

FIG. 1 is a block diagram showing part of the speech decoder, according to the present invention.

FIG. 2 is a plot showing an enhanced FFT spectrum of a speech frame after zero insertion.

FIG. 3a is a plot showing an FFT spectrum of a voiced-sound frame after zero insertion.

FIG. 3b is a plot showing an attenuation curve for modifying the FFT spectrum of a voiced-sound frame.

FIG. 3c is a plot showing the FFT spectrum of FIG. 3a after being attenuated according the attenuation curve as shown in FIG. 3b.

FIG. 4a is a plot showing an FFT spectrum of a stop-consonant frame after zero insertion.

FIG. 4b is a plot showing an attenuation curve for modifying the FFT spectrum of a stop-consonant frame.

FIG. 4c is a plot showing the FFT spectrum of FIG. 4a after being attenuated according the attenuation curve as shown in FIG. 4b.

FIG. 5a is a plot showing a different attenuation curve for modifying the FFT spectrum of a stop-consonant frame.

FIG. 5b is a plot showing the FFT spectrum of FIG. 4a after being attenuated according to the attenuation curve as shown in FIG. 5a.

FIG. 6 is a plot showing two different amplification curves for enhancing the amplitude of a first sibilant frame and that of the following sibilant frames.

FIG. 7a is a plot showing an FFT spectrum of a sibilant frame after zero insertion.

FIG. 7b is a plot showing the FFT spectrum of FIG. 6a after being amplified by an amplification curve similar to the curve as shown in FIG. 6.

FIG. 8a is a plot showing an FFT spectrum of a non-sibilant frame after attenuation.

FIG. 8b is a plot showing the attenuated spectrum of FIG. 8a after being modified by a moving average operation.

FIG. 9a is a schematic representation showing three windowed frames being processed by a frame cascading process.

FIG. 9b is a schematic representation showing a continuous sequence of frames as the result of frame cascading.

FIG. 10 is a flowchart illustrating the method of speech sound quality improvement, according to the present invention.

FIG. 11 is a block diagram showing a mobile terminal having a speech signal modification module, according to the present invention.

FIG. 12 is a block diagram showing a telecommunications network including a plurality of base stations each of which uses a speech signal modification module, according to the present invention.

### BEST MODE TO CARRY OUT THE INVENTION

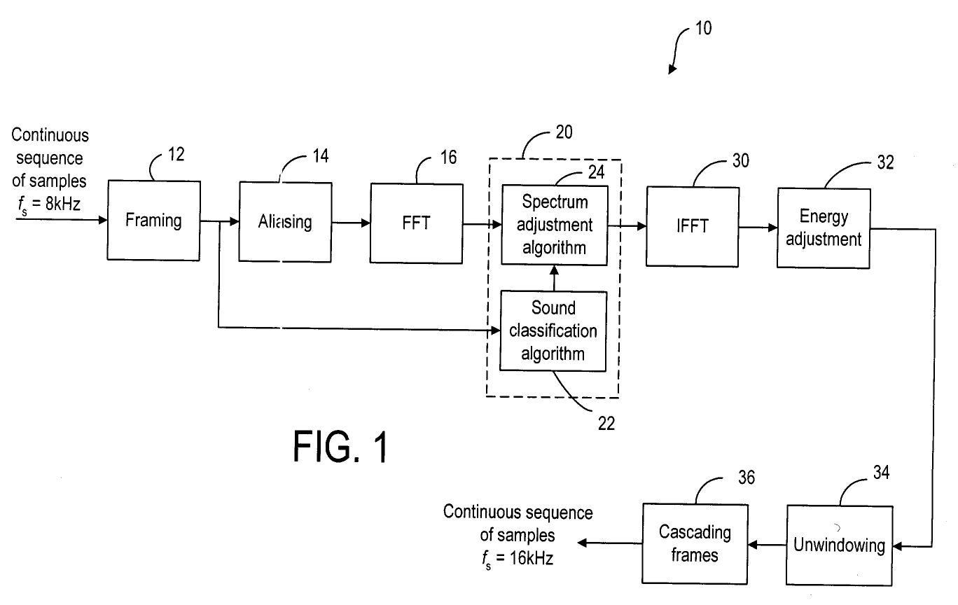

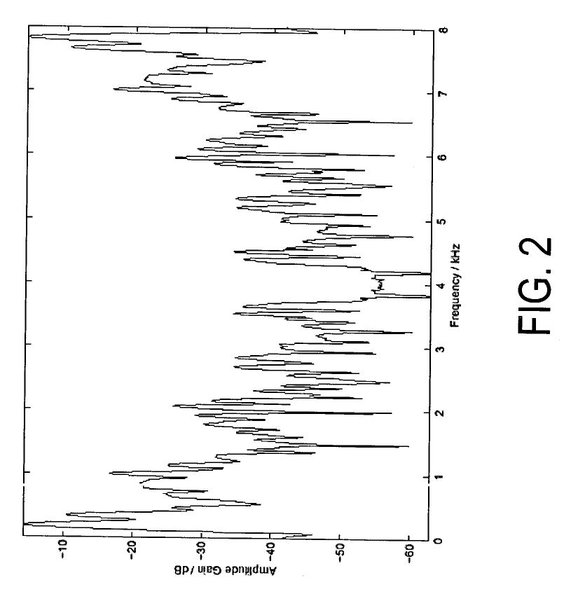

The present invention makes use of the original narrowband speech signal (0-4 kHz) that is received by a receiver, and generates a new speech signal by artificially expanding the bandwidth of the received speech in order to improve the naturalness of the speech sound, based on the new speech signal. With no additional information to be transmitted, the present invention generates new upper frequency components based on the characteristics of the transmitted speech signal. FIG. 1 shows a part of a speech decoder 10, according to the present invention. As shown, the input signal comprises a continuous sequence of samples at a typical sample frequency of 8 kHz. The input signal is divided by a framing block 12 into windows or frames, the edges of which are overlapping. The default size of the frame is 20 ms. With a sampling frequency fₛ=8 kHz, there are 160 samples in each frame. Each frame is windowed with a Hamming window of 30 ms (240 samples) so that each end of a frame overlaps with an adjacent frame by 5 ms. In the aliasing block 14, zeros are inserted between samples—typically one zero between two samples. As a result, the sampling frequency is doubled from 8 kHz to 16 kHz. After zero insertion, an FFT (fast Fourier Transform) spectrum is calculated in an FFT module 16. The length of the FFT is 1024. It should be noted that, after zero insertion, the enhanced FFT power spectrum has the original narrowband component in the range of 0-4 kHz and the mirror image of the same spectrum in the frequency range of 4 kHz to 8 kHz, as shown in FIG. 2.

The enhanced FFT spectrum is modified by a speech signal modification module 20, which comprises a sound classification algorithm 22 and a spectrum adjustment algorithm 24. According to the present invention, the sound classification algorithm 22 is used to classify the speech signals into a plurality of classes and then the spectrum adjustment algorithm 24 is used to modify the enhanced FFT spectrum based on the classification. In particular, the speech signals in the frames are first classified into two basic types: sibilant and non-sibilant. Sibilants are fricatives, such as /s/, /sh/ and /z/ that contain considerably more high frequency components than other phonemes. A fricative is a consonant characterized by the frictional passage of the expired breath through a narrowing at some point in a vocal tract. The non-sibilants are further classified into a voiced-sound type and a stop-consonant type. In general, the spectrum envelope of a voiced-sound in the lower frequency band (0-4 kHz) decays with frequency whereas the spectrum envelope of a sibilant rises with frequencies in the same frequency band. The spectrum of a voiced-sound such as a vowel differs sufficiently from the spectrum of a sibilant, rendering it possible to separate sibilants from non-sibilants. However, it is preferable to use the speech signals in the time domain, instead of the frequency domain, for speech signal classification. For example, it is possible to use the number of zero-crossings in the time domain and the energies of the time domain signals and their second derivatives to distinguish a sibilant from a non-sibilant. In particular, the speech signal in each frame is separated based on two quotients, q₁ and q₂:

q₁=N_{Z}/N_{S}

q₂=D_{E}/E_{S}

where N_{Z} is the number of zero-crossings in the speech signal frame or window in the time domain; N_{S} is the number of samples in the frame; D_{E} is the energy of the second derivative of the speech signal in the time domain, and E_{S} is the energy of the speech signal, which is the squared sum of the signal in the frame. Thus, q₁ is a measure indicative of the frequency content of the frame and q₂ is a measure related to the energy distribution with respect to frequencies in the frame. It should be noted that there are other measures that are also indicative of the frequency content, e.g., FFT coefficients, and the energy distribution, e.g., energy after any other high-pass filtering of the frame and can be used for sound classification, but the quotients q₁ and q₂ are simple to compute. The quotients are compared with two separate limiting values c₁ and c₂ in order to distinguish a sibilant from a non-sibilant. If q₁>c₁ and q₂>c₂, then the frame is considered as that of a sibilant. Otherwise, the frame is considered as that of a non-sibilant. For example, the limiting values c₁ and c₂ can be chosen as 0.6 and 8, respectively.

In general, the duration of a fricative is longer than the duration of other consonants in speech. To state more precisely, the duration of a sibilant is usually longer than the duration of a fricative (such as /f/ and /h/) that is not a sibilant. Thus, it is preferred that a third criterion is used to sort out sibilants from the speech signal: only a speech segment that has at least two consecutive frames that are considered as fricatives is processed as a sibilant. In that end, when one frame meets the requirement of q₁>c₁ and q₂>c₂, the sound classification algorithm 22 further examines at least one following frame to determine whether the requirement of q₁>c₁ and q₂>c₂ is also met.

Once the frames are sorted into sibilants and non-sibilants, the non-sibilant frames are further separated into frames with a voiced-sound and frames with a stop consonant based on the quotient q₁. Stop consonants are unvoiced consonants such as /k/, /p/ and /t/. For example, if q₁ is greater than 0.4, then the frame can be considered as that of a stop consonant. Otherwise, the frame is that of a voiced sound.

The criteria used for sound classification as described above are based on experimental facts, and they can be varied somewhat to change the recognition characteristics of the method. For example, if q₁ and/or q₂ are made smaller, e.g. 0.3 and 5, the method is less likely to detect all sibilants, but at the same time there are fewer false sibilants detected. Respectively, if q₁ and/or q₂ are made larger, e.g. 0.9 and 12, the method is more likely to detect all sibilants, but at the same time there are more false sibilants detected. The duration D threshold can also be varied with similar consequences, e.g., between 30 ms and 90 ms.

When the parameters q₁, q₂ and D are used to detect the sibilants, reasonable limits to the values of these parameters can be determined for each implementation based on the sensitivity and specificity of the method to detect the sibilants and fricatives, according to the present invention. In certain extreme conditions like very noisy circumstances, the values of the parameters can be extended even beyond the above ranges.

After the frames are sorted into different sound categories, the spectrum adjustment algorithm 24 is used to modify the amplitude of the enhanced FFT spectrum in the corresponding zero-inserted frames. As mentioned earlier, the enhanced FFT spectrum covers a frequency range of 0 to 8 kHz. The lower half of the frequency range has the original narrowband FFT spectrum and the higher half of the frequency range has the mirror image of the same spectrum. It is preferred that only the spectrum in the higher frequency band is modified and the lower frequency band is left unaltered. However, it is also possible to modify the lower frequency band in a separate process and the two processes are combined to provide a method of sound improvement wherein the entire spectrum is modified.

Voiced-sound Frames

The FFT spectrum in the higher frequency range is modified such that the amplitude is attenuated more as the frequency increases. The amplitude of the enhanced FFT spectrum of a voiced sound frame is attenuated based two parameters: attnlg and kx, which are calculated as follows:

attnlg=Lₘₐₓ−Lₐᵥₑ

kx=2.90−0.086*attnlg+0.0010*(attnlg)²

where Lₘₐₓ is the maximum level of the spectrum from 0-4 kHz and Lₐᵥₑ is the average level of the spectrum from 2-3.4 kHz. From these two parameters a step function having steps at intervals of 1 kHz can be formed in order to attenuate the amplitude spectrum from 4-8 kHz, and each step is obtained by increasing the attenuation gradually to the maximum attenuation given by

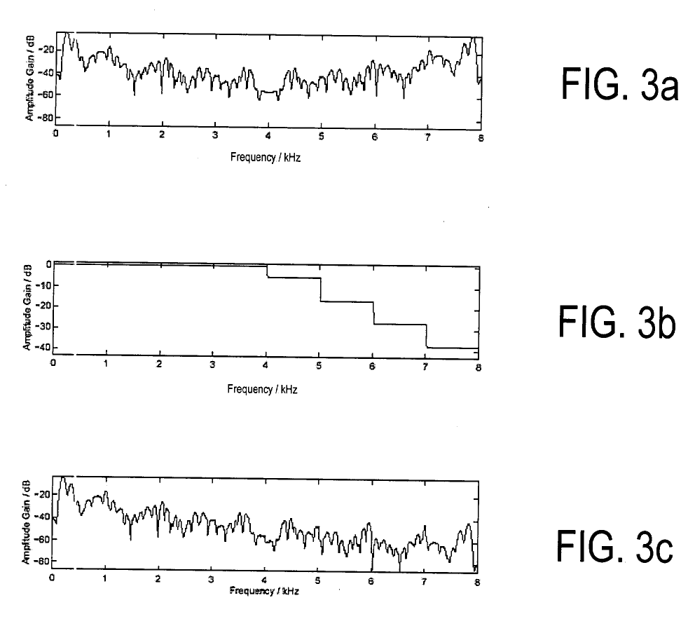

p=kx*attnlg*w

where w is a weigh factor that is proportional to the frequency of the maximal spectral component. The amplitude of the step function between 0-4 kHz is 0 dB. In order to show the result of amplitude attenuation, a typical amplitude spectrum of a voiced-sound frame is shown in FIG. 3a and an exemplary attenuation step function is shown in FIG. 3b. After attenuated by the step function, the amplitude spectrum is shown in FIG. 3c.

Stop-consonant Frames

For the stop consonant, it is preferred that the amplitude spectrum of each frame is attenuated in a similar fashion except that

attnlg=3(Lₘₐₓ−Lₐᵥₑ)

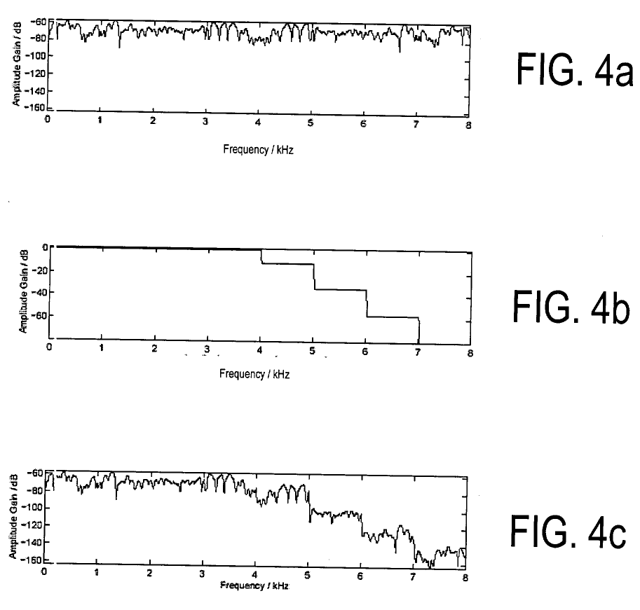

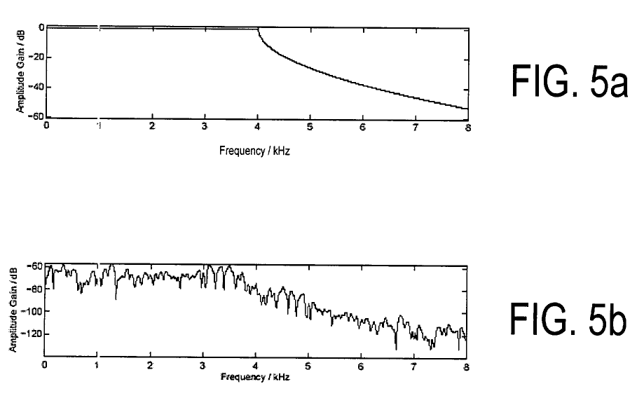

A typical amplitude spectrum of a stop-consonant frame is shown in FIG. 4a. An exemplary attenuation step function is shown in FIG. 4b. After attenuated by the step function, the amplitude spectrum is shown in FIG. 4c. Alternatively, the attenuation is carried out in a more gradual manner, as shown in FIGS. 5a- 5b. As shown in FIG. 5a, the attenuation of the amplitude of the spectrum starts at 4 kHz and the attenuation curve has the shape of a logarithmic function. FIG. 5b is the amplitude spectrum of FIG. 4a after being attenuated by the attenuation curve of FIG. 5a.

Sibilant Frames

In general, the envelope of the amplitude of the FFT spectrum after zero insertion of a sibilant frame increases from 0 to 4 kHz and decreases from 4 kHz to 8 kHz. It is desirable to modify the spectrum so that the amplitude of the spectrum in the higher frequency range is increased with frequencies. As mentioned earlier, only a speech segment that has at least two consecutive frames that meet the requirement of q₁>c₁ and q₂>c₂ is processed as a sibilant. In the sibilant speech segment, the amplitude of the enhanced FFT spectrum between 0-4.8 kHz is kept unchanged while the amplitude of the spectrum between 4.8 kHz and 8 kHz is enhanced by a logarithmic function attslidelg as follows:

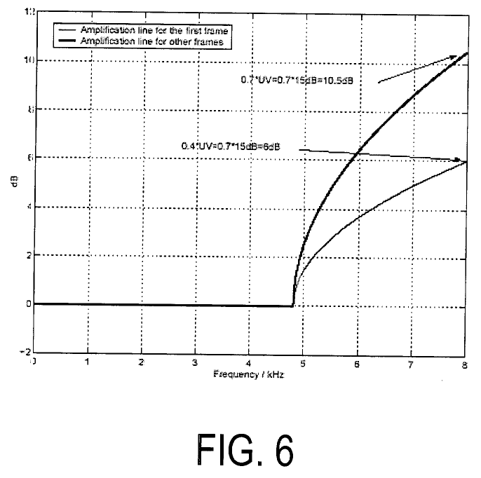

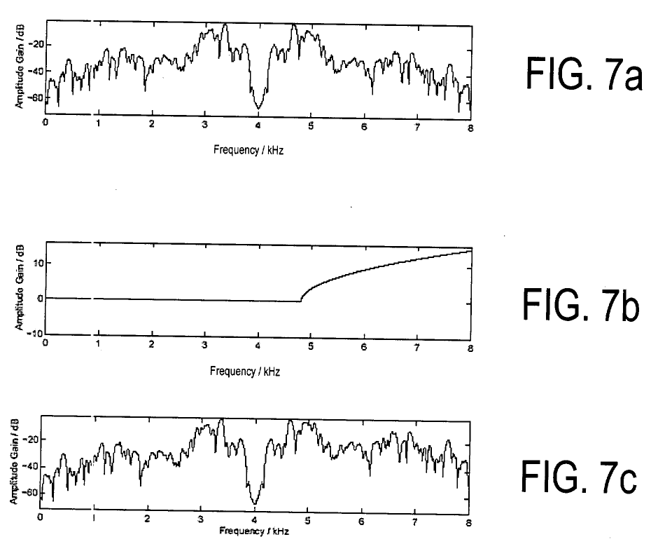

attslidelg=kUV*sqrt[(f−4800)/3200]

where UV is the dB-value of the difference in the amplitude spectrum in the frequency range 0.3 kHz-3 kHz (the difference can be calculated from the mean values of a number of samples at the two ends of the frequency range, for example), f is the frequency in Hz, and k=0.4 for the first sibilant frame and k=0.7 for the following sibilant frames. The amplification curve for the sibilant frames, with UV=15, is shown in FIG. 6. It should be noted that, after the amplification curve is determined, it is converted into a linear scale before its value is multiplied to the amplitude of the enhanced FFT spectrum. The amplified spectrum is shown in FIG. 7c. The original spectrum is shown in FIG. 7a and the used amplification curve is shown in FIG. 7b.

Moving Average

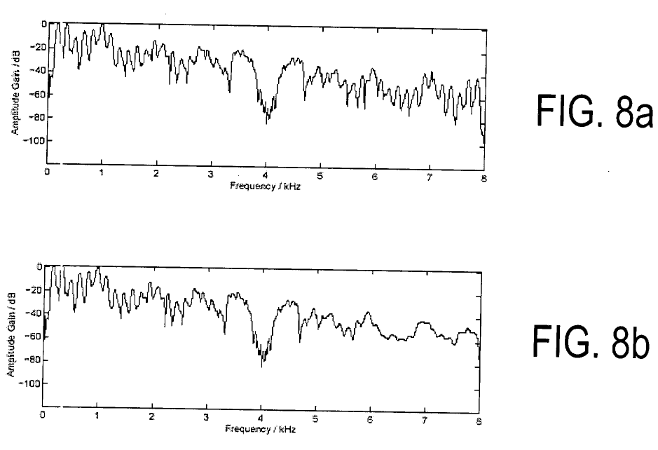

The purpose of using the moving average operation at the higher band (4 kHz-8 kHz) is to make the sound more natural by removing the harmonic structure. The moving average operation is the average of the amplitude spectrum over a number of samples and the number of samples is increased with the frequency range. The moving average is also carried out by the spectrum adjustment algorithm 24. For example, in the frequency range of 4 kHz-5 kHz, no averaging is carried out. In the frequency range of 5 kHz-6 kHz, the amplitude of the spectrum is averaged over 5 samples. In the frequency range of 6 kHz-7 kHz, the amplitude of the spectrum is averaged over 9 samples. Finally, in the frequency range of 7 kHz-8 kHz, the amplitude of the spectrum is averaged over 13 samples. FIG. 8a is an amplitude spectrum of a frame before moving average operation. FIG. 8b is the amplitude spectrum after moving average operation.

IFFT and Energy Adjusting

After processing the spectrum in the frequency domain, an inverse Fast Fourier Transform (IFFT) module 30 is used to convert the spectrum back to the time domain by inverse Fast Fourier Transform (IFFT). An IFFT having a length of 1024 is calculated from each frame. From the transform results, 480 first samples (30 ms) form the time domain representation of the frame. The energy of the each frame has changed after frequency expansion due to the addition of new spectral components to the signal Furthermore, the change of energy varies from frame to frame. Thus, it is preferred that an energy adjustment module 32 is used to adjust the energy of the wideband frame to the same level as it was in the original narrowband frame.

Unwindowing

At this stage, an unwindowing module 34 is used to compensate the windowing that was carried out in the computation of the FFT by multiplying all the processed frames by an inverse Hamming window. The length of the inverse window is 30 ms, 480 samples.

Cascading Frames

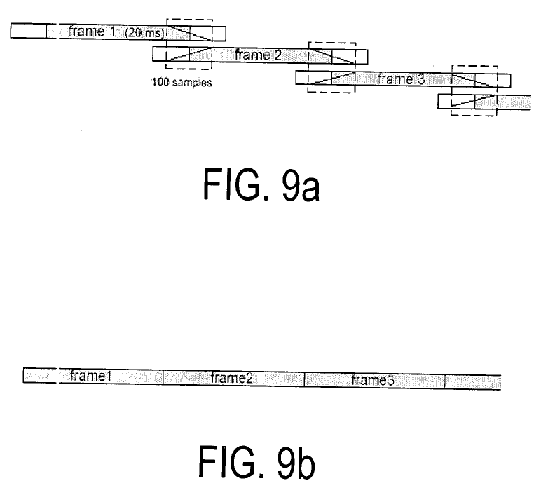

In order to obtain a continuous signal from the processed frames, a frame cascading module 36 is used to put the frames together by overlapping. It should be noted that the length of the windowed frame at this stage is 30 ms with a sample frequency of 16 kHz as compared to the actual frame of 20 ms. When the windowed frames are cascaded, it is preferred that the first 50 samples and last 50 samples of the 20 ms middle section of the windowed frame are averaged with samples in the adjacent frames, as shown in FIG. 9a. The averaging operation is used to avoid sudden jumps between actual frames. In the averaging procedure, a monotonic function with a linear slope is used so that the influence of a frame decreases linearly with time while the influence of the following frame increases linearly with time. After frame cascading, the continuous sequence of frames, as shown in FIG. 9b, comprises a continuous sequence of samples with a sample frequency of 16 kHz.

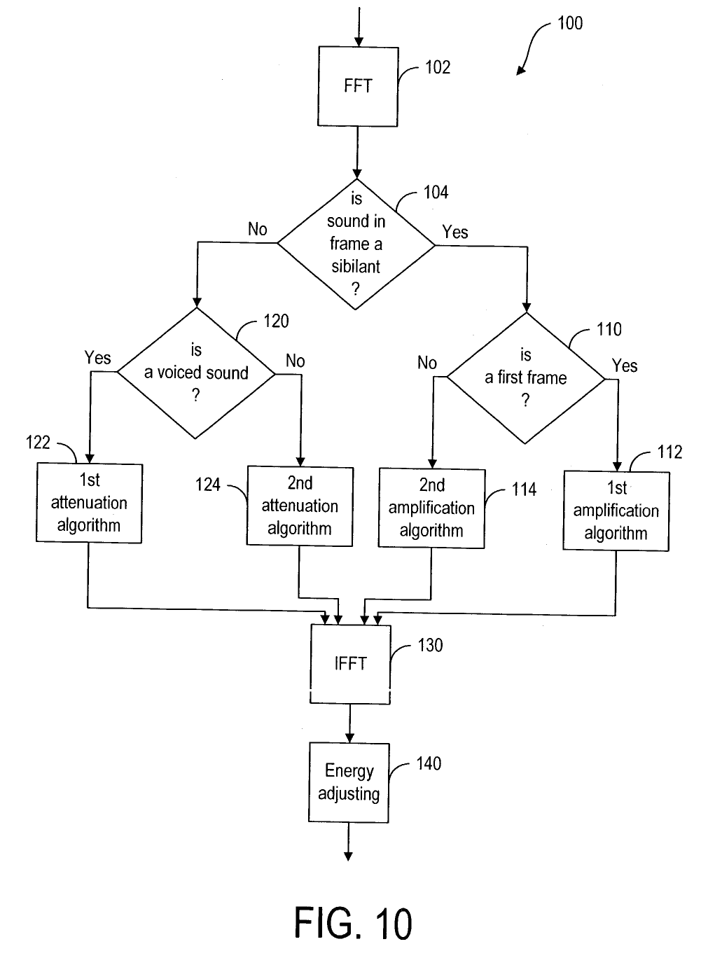

The method of artificially expanding the bandwidth of a received speech signal, according to the present invention, is illustrated in the flowchart 100, as shown in FIG. 10. As shown in FIG. 10, after the speech frames in the time domain are upsampled by the aliasing module (see FIG. 1), the upsampled frames are converted at step 102 into transformed frames in the frequency domain by an FFT module (see FIG. 1). It is decided at step 104 whether the transformed frames are indicative of a sibilant or a non-sibilant by the sound classification module (see FIG. 1) using the zero crossings, duration and energy information in the corresponding speech frame in the time domain. If a transformed frame is that of a non-sibilant, it is decided at step 120 whether the frame is that of a voiced sound or a stop-consonant. If the frame is that of a voiced sound, then the FFT spectrum of the speech frame is attenuated according to an attenuation curve at step 122. If the frame is that of a stop-consonant, then the FFT spectrum is attenuated according to another attenuation curve at step 124. However, if the speech segment associated with the transformed frames in the frequency domain is a sibilant as decided at step 104, then the FFT spectrum of those transformed frames is modified at step 112 or 114 depending on whether the frame is a first frame, as decided at step 110. After the speech frames in the frequency domain are modified based on the characteristics of the corresponding speech frames in the time domain, the modified speech frames are converted back to a plurality of speech frames in the time domain by an inverse FFT module at step 130, and the energy of these speech frames in the time domain is adjusted by an energy adjustment module at step 140 for further processing.

The method of artificially expanding the bandwidth of a received speech signal, according to the present invention, can be summarized as having three main steps:

In the first step, the speech frames in the time domain are upsampled by inserting zeros between every other sample of the original signal, thereby doubling the sampling frequency and the bandwidth of the digital speech signal. Consequently, the aliased frequency components in the speech frames between 4 kHz and 8 kHz are created, if the original sampling frequency is 8 kHz.

At the second step, the level of the aliased frequency components is adjusted using an adaptive algorithm based on the classification of the speech segment. Adjustment of the aliased frequency components is computed from the original narrowband of the FFT spectrum of the up-sampled speech signal.

At the third step, inverse Fourier Transform is used to convert the adjusted spectrum into to the time domain in order to produce a new speech sound with a bandwidth of 300 kHz 7.7 kHz if the original speech signal is transmitted with frequency components between 300 Hz and 3.4 kHz.

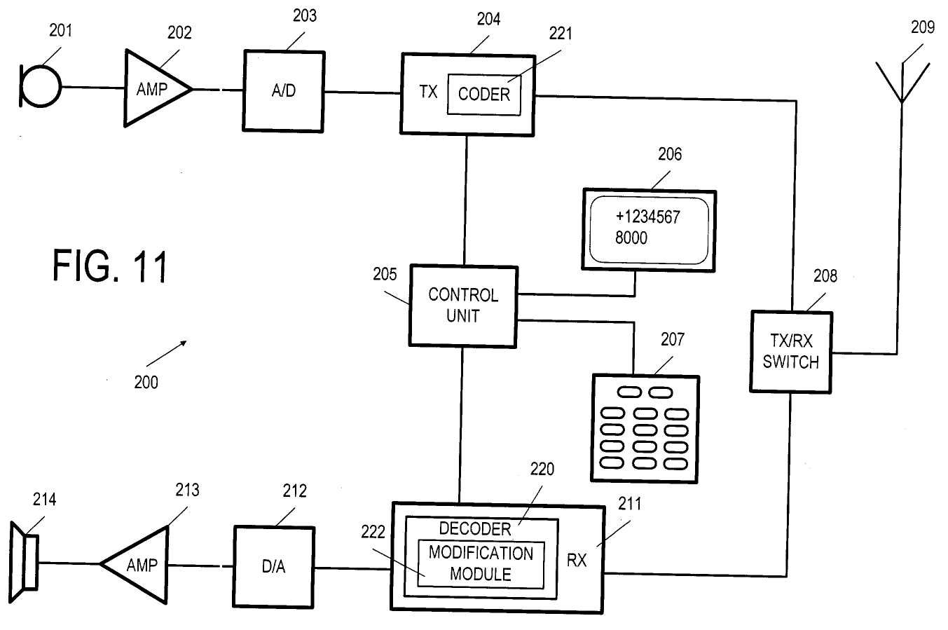

FIG. 11 shows a block diagram of a mobile terminal 200 according to one exemplary embodiment of the invention. The mobile terminal 200 comprises parts typical of the terminal, such as a microphone 201, keypad 207, display 206, earphone 214, transmit/receive switch 208, antenna 209 and control unit 205. In addition, FIG. 11 shows transmitter and receiver blocks 204, 211 typical of a mobile terminal. The transmitter block 204 comprises a coder 221 for coding the speech signal. The transmitter block 204 also comprises operations required for channel coding, deciphering and modulation as well as RF functions, which have not been drawn in FIG. 11 for clarity. The receiver block 211 also comprises a decoding block 220 according to the invention. Decoding block 220 comprises a speech signal modification module 222, similar to the speech signal modification module 20 shown in FIG. 1. The signal coming from the microphone 201, amplified at the amplification stage 202 and digitized in the A/D converter, is taken to the transmitter block 204, typically to the speech coding device comprised by the transmit block. The transmission signal, which is processed, modulated and amplified by the transmit block, is taken via the transmit/receive switch 208 to the antenna 209. The signal to be received is taken from the antenna via the transmit/receive switch 208 to the receiver block 211, which demodulates the received signal and decodes the deciphering and the channel coding. The speech signal modification module 222 artificially expands the received signal in order to improve the quality of the speech. The resulting speech signal is taken via the D/A converter 212 to an amplifier 213 and further to an earphone 214. The control unit 205 controls the operation of the mobile terminal 200, reads the control commands given by the user from the keypad 207 and gives messages to the user by means of the display 206.

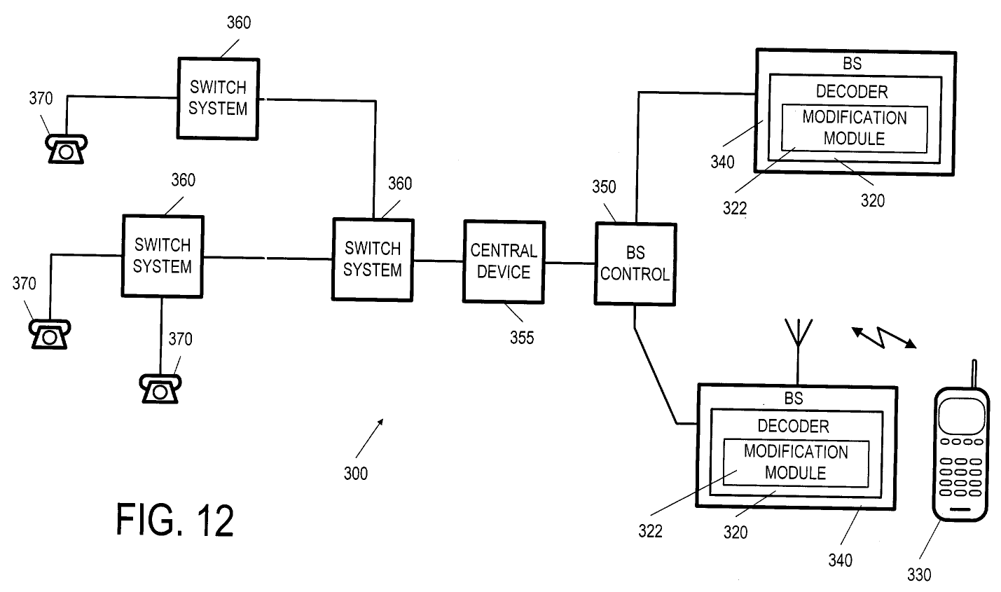

The speech signal modification module 20, according to the invention, can also be used in a telecommunication network 300, such as an ordinary telephone network, or a mobile station network, such as the GSM network. FIG. 12 shows an example of a block diagram of such a telecommunication network. For example, the telecommunication network 300 can comprise telephone exchanges or corresponding switching systems 360, to which ordinary telephones 370, base stations 340, base station controllers 350 and other central devices 355 of telecommunication networks are coupled. Mobile terminal 330 can establish connection to the telecommunication network via the base stations 340. A decoding block 320, which includes a speech signal modification module 322 similar to the modification module 20 shown in FIG. 1, can be particularly advantageously placed in the base station 340, for example. It should be noted that the speech signal modification module 322 can be applied at a transcoder which is used to transcode speech arriving from the PSTN (Public switched telephone network) or PLMN (Public land mobile network) like GSM or IS-95 to a 3G mobile network. The transcoding typically takes place from a narrowband signal representation in PCM (Pulse code modulation) to, e.g., WB-AMR (Wideband adaptive multirate), so that the mobile terminal 330 does not need to carry out the speech signal modification. The decoding block 320 can also be placed in the base station controller 350 or other central or switching device 355, for example. As such, the speech signal modification module 332 can be used to improve the quality of the speech by artificially expanding the bandwidth of received speech signals in the base station or the base station controller. The speech signal modification module 332 can also be used in personal computers, Voice-over-IP, and the like.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method of improving speech in a plurality of signal segments having speech signals in a time domain, said method characterized by
upsampling the signal segments for providing upsampled segments in the time domain;
converting the upsampled segments into a plurality of transformed segments having speech spectra in a frequency domain;
classifying the speech signals into a plurality of classes based on at least one signal characteristic of the speech signals;
modifying the speech spectra in the frequency domain based on the classes for providing modified transformed segments; and
converting the modified transformed segments into speech data in the time domain.

2. The method of claim 1, wherein each signal segment comprises a plurality of signal samples, said method characterized in that
said upsampling is carried out by inserting a value between adjacent signal samples in the signal segment.

3. The method of claim 2, characterized in that the inserted value is zero.

4. The method of claim 1, wherein the speech signals include a time waveform having a plurality of crossing points on a time axis, said method characterized in that
said at least one characteristic of the speech signals is indicative of the number of crossing points in a signal segment.

5. The method of claim 4, wherein each of the signal segments comprises a number of signal samples, said method characterized in that
said at least one characteristic of the signal segments is indicative of a ratio of the number of crossing points in the signal segment and the number of signal samples in said signal segment.

6. The method of claim 1, wherein said at least one signal characteristic of the speech signals is indicative of energy in the signal segments.

7. The method of claim 1, characterized in that
said at least one signal characteristic of the speech signals is indicative of a ratio of an energy of a second derivative of the speech signals and an energy in the speech signals.

8. The method of claim 5, wherein the plurality of classes include a voiced sound and a stop consonant, said method characterized in that
the speech signals are classified as the voiced sound if the ratio is smaller than a predetermined value and
the speech signals are classified as the stop consonant if the ratio is greater than the predetermined value.

9. The method of claim 5, wherein the plurality of classes include a sibilant class and a non-sibilant class, said method characterized in that
the speech signals are classified as the sibilant class if the ratio is greater than a predetermined value, and
the speech signals are classified as the non-sibilant class if the ratio is smaller than or equal to the predetermined value.

10. The method of claim 9, wherein said at least one signal characteristic of the speech signals is indicative of a further ratio of an energy of a second derivative of the speech signals and an energy in the speech signals, said method further characterized in that
the speech signals are classified as the sibilant class if the further ratio is also greater than a further predetermined value.

11. The method of claim 9, wherein each of the speech spectra has a first spectral portion in a lower frequency range and a second spectral portion in a higher frequency range, said method characterized in that
the second spectral portion is enhanced for providing the modified transformed segments if the speech signals are classified as the sibilant class.

12. The method of claim 9, wherein each of the speech spectra has a first spectral portion in a lower frequency range and a second spectral portion in a higher frequency range, said method characterized in that
the second spectral portion is attenuated for providing the modified transformed segments if the speech signals are classified as the non-sibilant class.

13. The method of claim 1, wherein each of the speech spectra has a first spectral portion in a lower frequency range and a second spectral portion in a higher frequency range, said method further characterized by
smoothing the second spectral portion by an averaging operation prior to converting the modified transformed segments into the speech data in the time domain.

14. A network device in a telecommunications network, wherein the network device is capable of
receiving data indicative of speech; and
partitioning the received data into a plurality of signal segments having speech signals in a time domain, said network device characterized by
an upsampling module for upsampling the signal segments for providing upsampled segments in the time domain;
a transform module for converting the upsampled segments into a plurality of transformed segments having speech spectra in a frequency domain;
a classification algorithm for classifying the speech signals into a plurality of classes based on at least one signal characteristic of the speech signals; and
an adjustment algorithm for modifying the speech spectra in the frequency domain based on the classes for providing modified transformed segments.

15. The device of claim 14, further characterized by
an inverse transform module for converting the modified transformed segments into speech data in the time domain.

16. The device of claim 14, wherein each of the signal segments comprises a number of signal samples for sampling a waveform having a plurality of crossing points on a time axis, said device characterized in that
the classification algorithm is adapted to classify the speech signals based on a ratio of the number of crossing points and the number of signal samples in at least one signal segment.

17. The device of claim 14, characterized in that
the classification algorithm is adapted to classify the speech signals based on a ratio of an energy of a second derivative in the speech signal and an energy in at least one signal segment.

18. The device of claim 17, wherein each of the signal segments comprises a number of signal samples for sampling a waveform having a plurality of crossing points on a time axis, said device further characterized in that
the classification algorithm is adapted to classify the speech signals also based on a further ratio of the number of crossing points and the number of signal samples in said at least one signal segment.

19. The device of claim 14, wherein the plurality of classes include a sibilant class and a non-sibilant class, and each of the speech spectra has a first spectral portion in a lower frequency range and a second spectral portion in a higher frequency range, said device characterized in that the adjustment algorithm is adapted to
enhance the second spectral portion if the speech signals are classified as the sibilant class, and
attenuate the second spectral portion if the speech signals are classified as the non-sibilant class.

20. The device of claim 14, wherein each of the speech spectra has a first spectral portion in a lower frequency range and a second spectral portion in a higher frequency range, said device further characterized in that
the adjustment algorithm is adapted to smooth the second spectral portion by an averaging operation.

21. The device of claim 19, further characterized in that
the adjustment algorithm is adapted to smooth the second spectral portion by an averaging operation.

22. The device of claim 14, comprising a mobile terminal in the telecommunications network.

23. The device of claim 14, comprising a base station in the telecommunications network.

24. The device of claim 14, comprising a transcoder in the telecommunications network.

25. A sound classification algorithm for use in a speech decoder, wherein speech data in the speech decoder is partitioned into a plurality of signal segments having speech signals in a time domain and each signal segment includes a number of signal samples, and wherein the speech signals include a time waveform having a plurality of crossing points on a time axis, said classification algorithm characterized by
classifying the speech signals into a plurality of classes based on a ratio of the number of crossing points and the number of signal samples in at least one signal segment.

26. The sound classification algorithm of claim 25, wherein the speech signals are classified into a sibilant class and a non-sibilant class, said classification algorithm characterized in that
the speech signals are classified as the sibilant class if the ratio is greater than a predetermined value.

27. The algorithm of claim 25, characterized in that
said classifying is also based on a further ratio of an energy of a second derivative of a second derivative of the speech signal and an energy in said at least one signal segment.

28. The sound classification algorithm of claim 27, wherein the speech signals are classified into a sibilant class and a non-sibilant class, said classification algorithm characterized in that
the speech signals are classified as the sibilant class if the ratio is greater than a first predetermined value and the further ratio is greater than a second predetermined value.

29. The sound classification algorithm of claim 28, characterized in that
the first predetermined value is substantially equal to 0.6, and
the second predetermined value is substantially equal to 8.

30. A spectral adjustment algorithm for use in a speech decoder capable of
receiving speech data,
partitioning speech data into a plurality of signal segments having speech signals in the time domain,
upsampling the signal segments for providing upsampled segments, and
converting the upsampled segments into a plurality of transformed segments, each having a first speech spectral portion in a first frequency range and a second speech spectral portion in a second frequency range higher than the first frequency range, said adjustment algorithm characterized by
enhancing the second speech spectral portion, if the speech signals are classified as a sibilant class, and
attenuating the second speech spectral portion, if the speech signals are classified as a non-sibilant class.

31. The spectral adjustment algorithm of claim 30, further characterized by
smoothing the second speech spectral portion by an averaging operation.

32. The spectral adjustment algorithm of claim 30, wherein when the speech signals in at least two consecutive signal segments are classified as the sibilant class, said at least two consecutive signal segments including a leading segment and at least one following segment, said adjustment algorithm characterized by
enhancing the second speech spectral portion in the leading segment by a first factor, and
enhancing the second speech spectral portion in said at least one following segment by a second factor greater than the first factor.
